(19) United States
(12) Patent Application Publication
(10) Pub. No.: US 2002/0088750 A1
(43) Pub. Date: Jul. 11, 2002

(54) Rotting assembly with adsorbent sheet

(76) Inventor: Karl-Wilhelm Faber, Alzey (DE)

Correspondence Address: MARSHALL, GERSTEIN & BORUN, 6300 SEARS TOWER, 233 SOUTH WACKER, CHICAGO, IL, 60606-6357, US

(21) Appl. No.: 09/994,193

(22) Filed: Nov. 26, 2001

(30) Foreign Application Priority Data
Nov. 28, 2000 (DE) 100 59 031.4

(51) Int. Cl. C02F 9/00

(52) U.S. Cl. 210/631

(57) ABSTRACT

The present invention relates to a method and a system for mechanical biological waste treatment, the waste being first homogenized, comminuted and moistened thoroughly and being then biologically treated in an aerobic rotting assembly ventilated by means of the chimney-draft method.

To reduce the emission of pollutants of the rotting assembly, the surface of the rotting assembly is covered with at least one adsorbent sheet.

The present invention relates to a method for the mechanical biological treatment of waste, wherein the waste is first homogenized, comminuted and moistened thoroughly and is then biologically treated in an aerobic rotting assembly which is ventilated by the chimney-draft method.

The present invention further relates to a rotting assembly for the biological waste treatment of comminuted, homogenized and thoroughly moistened waste which is stored on an air-permeable material having passed therethrough ventilation elements through which air is drawn from the outside according to the chimney-draft method to a chimney arranged in the rotting assembly for ventilating the waste, and to a system for biological waste treatment with such a rotting assembly.

Such a method and such a rotting assembly are already used in the modern waste disposal industry. The residual waste, such as domestic waste, bulky refuse, industrial waste that is similar to domestic waste, and sewage sludge are first subjected to an input inspection during which coarse recyclable materials and coarse unwanted materials are sorted out. Subsequently, a mechanical pretreatment is carried out, the waste being optionally comminuted, homogenized and thoroughly moistened, e.g. in mixers, possibly by adding sewage sludge or seeping water. The biological treatment then takes place in aerobic stacks or assemblies for a period of at least 9 months, said assemblies being ventilated by means of the so-called chimney-draft method. In the case of the known rotting assemblies, the waste is deposited on air-permeable material, preferably wooden pallets which are placed one on top of the other in an inclined manner or in staggered fashion, so that ventilation elements can be passed below the pallets. A biofilter layer is placed on the waste. DE 19 7804 018.0 already discloses a method and a rotting assembly for mechanical biological waste treatment, wherein the biofilter layer consists of a structured layer of particles having a particle size of 25 to 80 mm and of a cover layer applied onto said structured layer.

In such rotting assemblies, gases which may contain pollutants and which escape upwards from the rotting assembly are generated during aerobic decomposition of the waste. It thus happens that the previously described rotting assemblies no longer meet the increasingly higher demands of air pollution control regulations.

Starting from this prior art, it is the object of the present invention to provide a method and a rotting assembly of reduced pollutant emission.

According to the invention this object is achieved with a method of the above-mentioned type in that the surface of the rotting assembly is covered with at least one adsorbent sheet. The adsorbent sheet which is arranged on the surface of the rotting assembly adsorbs, on it surface, pollutants of the upwardly rising gas generated during aerobic decomposition of the waste. Despite the retaining capacity of the adsorbent, a ventilation of the assembly is ensured. Thus the pollutant emission of the rotting assembly can be reduced considerably. In addition, the adsorbent sheet prevents the emission of odors and dust and additionally protects the rotting assembly against cooling. The use of activated carbon as an adsorbent is inexpensive and simple.

A biofilter layer can be formed between the adsorbent sheet and the waste, and a structured layer consisting of particles of a particle size of 25 to 80 mm can be placed on the wastes for producing the biofilter layer and a cover layer can be applied onto the structured layer. Such a structure of the biofilter layer makes it possible that fine ventilation channels through which the rotting assembly can breathe remain therein even after a long period of time. Such a biofilter layer guarantees a permanent ventilation of the rotting assembly, which is in particular necessary in combination with the adsorbent sheets, whereby the rotting assembly is ventilated to a sufficient degree.

The rotting assemblies are not covered with the adsorbent sheet for the whole period of time required for biological decomposition, but the adsorbent sheet only remains on the rotting assembly for about 4 to 6 weeks. During this period the pollutant emission has already taken place for its greatest part. After said period the rotting assembly need no longer be covered with an adsorbent sheet. The adsorbent sheet which is removed from the rotting assembly after 4 to 6 weeks can then be used for another rotting assembly. The re-use of the adsorbent sheets that have been employed is environmentally friendly and cost-saving in addition.

In the chimney portion of the rotting assembly, the latter is covered with a multiple layer of the adsorbent sheet. In particular, the rotting assembly is covered in the chimney portion with a fourfold layer of the adsorbent sheet. It is thereby ensured that the pollutants are also sufficiently adsorbed in the chimney portion where an increased pollutant emission is observed because of the chimney-draft method.

According to a preferred embodiment of the present invention, the rotting assembly which is covered with the activated carbon sheet is installed in a closed hall. Thus pollutants which might pass through the activated carbon sheet are not passed to the outside. It is advantageous when in the closed hall the upwardly rising gases which are generated during aerobic decomposition of the waste are sucked off on the ceiling and are again passed from there via pipes below the assembly. Thus, the gases which are upwardly rising from the rotting assembly serve the renewed ventilation of the rotting assembly. Such a recycling ensures that the gases exiting from the rotting assembly pass through the activated carbon sheet several times, thereby ensuring an adequate filtering of the gases. The air is discharged from the hall via a chimney mounted on the hall, and the air discharged via the chimney can further be subjected to an after-purifying treatment with activated carbon.

The rotting assembly according to the invention is characterized in that the surface of the rotting assembly is formed by an adsorbent sheet. Preferred embodiments are shown in the subclaims.

The present invention shall now be described with the reference to the following figures, of which:

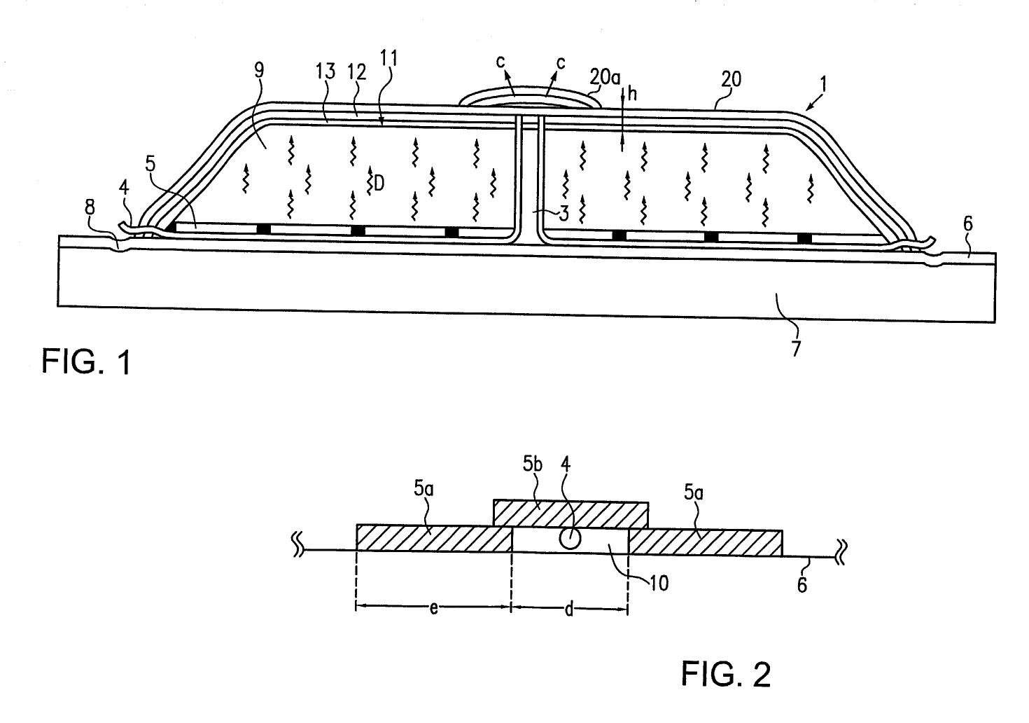

FIG. 1 is a schematic cross-section through a rotting assembly according to the invention;

FIG. 2 is a schematic cross-sectional view through a section of the wooden pallets;

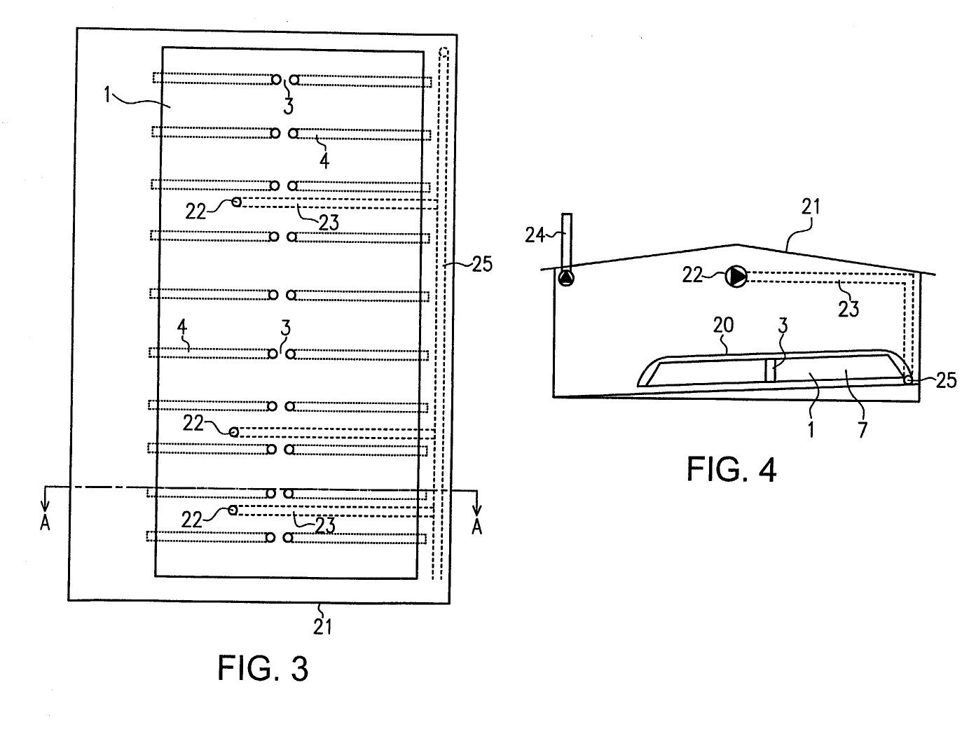

FIG. 3 is a section taken through a hall in which the rotting assembly according to the invention is installed; and

FIG. 4 shows a section taken along line A-A in FIG. 3.

As can be seen from the schematic cross-section of the rotting assembly according to the invention in FIG. 1, a solid drainable surface 6 is arranged on base 7 and is provided with discharge troughs 8 for backwater. Air-permeable material, in the present embodiment wooden pallets 5, is arranged on said solid surface 6. The pallets are arranged in the way shown in FIG. 2, two pallets 5a each being arranged side by side at a distance d on the solid surface 6. A further pallet 5b rests on pallets 5a, thereby forming a cavity 10 through which one or more ventilation elements 4, in the instant embodiment a slotted PVC tube, can be passed. The arrangement of the pallets and the structure of the whole rotting assembly may be of the type as is e.g. described in DE 19 804 018.0. Waste 9 is stored on top of the pallets. In the center of the rotting unit, ventilation elements 4 extend upwards, thereby forming a chimney 3.

On the waste 9, a biofilter layer 11 is arranged with a height h of about 30 cm. Said biofilter layer is of a two-layered structure. The lower layer facing the waste 9 is a structured layer which preferably consists of sieved compost residues of a compost unit and has particles of a particle size ranging from 25 to 80 mm. These particles should be structurally stable particles which, when dumped, form air-permeable channels, thereby allowing the rotting assembly to breathe through said structured layer 13. The structured layer, which is approx. 15 cm high, is then covered by the cover layer 12 positioned thereabove. For the formation of the cover layer, part of the fraction of <60 mm as sieved out from the wastes is used. Structured layer 13 and cover layer 12 jointly form the biofilter layer. The biofilter layer upholds the breathing activity while preventing the rotting assembly from cooling down. The rotting assembly is covered on its surface with at least one adsorbent sheet 20. In this embodiment, an activated carbon sheet 20 serves as the adsorbent sheet. Other suitable adsorbents, such as Tenax, may also be used. The activated carbon sheet has a thickness of 2.5 mm and a weight of 335 g/m². The activated carbon sheet comprises activated carbon and a tissue holding the activated carbon. The activated carbon sheet 20 covers the whole surface of the rotting assembly 1. Thus, the upwardly rising gases generated during aerobic decomposition of the waste, which are shown by arrows D, must pass through the activated carbon sheet 20 before exiting to the outside. The activated carbon of the activated carbon sheet 20 adsorbs, on its surface, the pollutants contained in the upwardly rising gases without impairing the breathing activity of the rotting assembly 1. Thus, the pollutant emission of the rotting assembly 1 can be reduced considerably. In the area of chimney 3 where an increased pollutant emission is observed, the rotting assembly is covered with the activated carbon sheet 20 in several layers. In the instant embodiment, it is covered with four layers to ensure that the exiting pollutants are adsorbed to an adequate degree.

In a method for mechanical biological waste treatment, the waste as arises in households or built-up areas is mechanically pretreated after having been subjected to an input inspection and after coarse recyclable substances and unwanted substances have been removed, namely in that the waste is e.g. homogenized and comminuted in a mixer and optionally thoroughly moistened by adding sewage sludge or seeping water, so that it is optimally prepared for the subsequent biological treatment.

The biological treatment is carried out in a rotting assembly as shown in FIG. 1. Wooden pallets on which the waste 9 is deposited serve as a base for the waste. Ventilation elements 4, preferably slotted PVC tubes, are passed through the wooden pallets, the ventilation elements charging air along their length from below into the rotting assembly 1, with the air then rising upwards. The waste 9 can be degraded aerobically by way of said ventilation. Since the rotting assembly warms up on the whole in this process, it will entrain air from the outside via the ventilation elements 4. The air which has warmed up rises upwards and can enter to the outside via the chimney 3 and through the multiple activated carbon sheets 20. An even aeration of the waste 9 is ensured by this function. The biofilter layer 12, 13 is then placed on the waste 9. Finally, the activated carbon sheet 20 is placed on the biofilter layer 12, 13. Gases generated during aerobic decomposition of the waste will, as shown by arrows D, rise upwards and pass through the activated carbon sheet 20 before exiting to the outside; water vapor is also produced in this process.

The water vapor is partly retained by the biofilter layer 12, 13 according to the invention. Pollutants which are contained in the gases which exit from the rotting assembly 1 to the outside are adsorbed by the surface of the activated carbon of the activated carbon sheet 20. After about 4 to 6 weeks the activated carbon sheet 20 is removed from the rotting assembly 1 because during this period the pollutant emission has already taken place for its greatest part. The removed activated-carbon sheet 20 can then be re-used for another assembly which has freshly been prepared. After the rotting process, which takes place for months, e.g. 9 months, fractions of a high calorific value can be separated. The other fraction can be deposited in a thin layer on a waste dump.

According to a preferred embodiment, the rotting assembly 1 of the invention as shown in FIG. 1 is installed in a hall 21. As becomes apparent from FIG. 3, the whole rotting assembly 1 comprises several portions with corresponding ventilation pipes 4 and several chimney portions 3 which have been provided one after the other. As shown in FIG. 4, the rotting assembly 1 is obliquely installed on a downwardly inclined base 7. The rotting assembly is therefore installed on a sloping base so that backwater can flow off. The surface of the rotting assembly 1 is covered by activated carbon sheets 20. At least one suction device 22 is arranged on the ceiling of the hall for sucking off upwardly rising gases which are generated during aerobic decomposition of the waste and which have exited from the rotting assembly 1. From this place the exhaust air is passed via pipes 23 to a distributor system 25 which is positioned on the floor of the hall. From said place the exhaust air is again passed below the assembly 1. In particular, the exhaust air is again passed into the ventilation elements 4 for ventilating the rotting assembly 1. This effects a recycling which guarantees that the exhaust air passes from the rotting assemblies 1 through the activated carbon sheet 20 several times, whereby an adequate purification of the exhaust air from the rotting assemblies 1 is ensured. Hence, the pollutant emission in the rotting assemblies 1 can be reduced even further. The air is discharged from the hall via a chimney 24 which is laterally mounted at the hall 21. In said chimney 24 the exhaust air may optionally be subjected to an afterpurification with activated carbon.

1. A method for mechanical biological waste treatment, the waste being first homogenized, comminuted and moistened thoroughly and then biologically treated in an aerobic rotting assembly (1) ventilated by means of the chimney-draft method, characterized in that the surface of said rotting assembly (1) is covered with at least one adsorbent sheet (20)

2. The method according to claim 1, characterized in that said adsorbent sheet (20) is an activated carbon sheet.

3. The method according to claim 1 or 2, characterized in that a biofilter layer (13, 12) is formed between said waste and said activated carbon sheet (2).

4. The method according to claim 3, characterized in that for the formation of said biofilter layer a structured layer of particles of a particles size of 25 to 80 mm is applied to said wastes and a cover layer is applied onto said structured layer.

5. The method according to at least one of claims 1 to 4, characterized in that said rotting assembly (1) remains covered by said adsorbent sheet (20) for about four to six weeks.

6. The method according to at least one of the preceding claims, characterized in that said rotting assembly (1) is covered in a chimney portion (3) with a multiple layer of said adsorbent sheet.

7. The method according to claim 6, characterized in that said rotting assembly (1) is covered with a fourfold layer of said adsorbent sheet.

8. The method according to at least one of the preceding claims, characterized in that after said adsorbent sheet has been removed from said rotting assembly (1), said sheet is used for another rotting assembly.

9. The method according to at least one of the preceding claims, characterized in that said rotting assemblies (1) which are covered with said adsorbent sheets are installed in a closed hall (21).

10. The method according to claim 9, characterized in that upwardly rising gases generated in said closed hall (21) during aerobic decomposition of said waste are sucked off on the ceiling and are again passed from said ceiling via pipes below said rotting assembly.

11. The method according to claim 10, characterized in that the air is discharged from said hall via a chimney (24) mounted on said hall.

12. The method according to claim 11, characterized in that the air discharged via said chimney is subjected to afterpurification with activated carbon.

13. A rotting assembly for the biological waste treatment of comminuted, homogenized and thoroughly moistened waste (9) which is stored on an air-permeable material (5) having passed therethrough ventilation elements (4) through which air is drawn from the outside by means of the chimney-draft method to a chimney (3) arranged in said rotting assembly (1) for ventilating said waste (9), characterized in that the surface of said rotting assembly is formed by an adsorbent sheet (20),

14. The rotting assembly according to claim 13, characterized in that said adsorbent sheet (20) is an activated carbon sheet.

15. The rotting assembly according to claim 13 or 14, characterized in that a biofilter layer (12, 13) is formed between said waste and said adsorbent sheet (20).

16. The rotting assembly according to claim 15, characterized in that said biofilter layer consists of a structured layer (13) of particles of a particle size of 25 to 80 mm which is placed on said waste, and of a cover layer (12) placed on said structured layer.

17. The rotting assembly according to any one of claims 13 to 16, characterized in that said rotting assembly (1) is covered in said chimney portion (3) with a multiple layer of said adsorbent sheet (20).

18. The rotting assembly according to claim 17, characterized in that said rotting assembly is covered in said chimney portion (3) with a fourfold layer of said adsorbent sheet (20).

19. The rotting assembly according to at least one of claims 12 to 16, characterized in that said adsorbent sheet (20) has a thickness of 1 to 10 mm.

20. The rotting assembly according to claim 18, characterized in that said adsorbent sheet has a thickness of 2.5 mm.

21. A system for biological waste treatment, comprising at least one rotting assembly (1) according to any one of claims 13 to 20 and a closed hall (21) in which said rotting assembly (1) is installed.

22. The system according to claim 21, characterized in that said hall is provided on the ceiling with an air suction device (22) for sucking off upwardly rising gases generated during aerobic decomposition of said waste.

23. The system according to claim 22, characterized in that said suction device (22) is connected to pipes (23, 25) which are arranged such that the sucked-off exhaust air is again guided below said rotting assembly (1).

24. The system according to claim 23, characterized in that said exhaust air is guided into ventilation elements (4).

25. The system according to any one of claims 20 to 24, characterized in that said hall comprises a chimney (24) for discharging air from said hall (21).

26. The system according to claim 25, characterized in that said chimney (24) of said hall (21) comprises an afterpurification device.

27. The system according to claim 26, characterized in that said afterpurification device comprises activated carbon.
